(19) United States
(12) Patent Application Publication
(10) Pub. No.: US 2011/0269485 A1
(43) Pub. Date: Nov. 3, 2011

(54) METHOD AND NETWORK NODE FOR SENDING A MESSAGE TO A PLURALITY OF DEVICES OF A USER

(75) Inventor: Patrice Varinot, Montreal (CA)

(73) Assignee: TELEFONAKTIEBOLAGET L M ERICSSON (PUBL), Stockholm (SE)

(21) Appl. No.: 12/967,725

(22) Filed: Dec. 14, 2010

Related U.S. Application Data
(60) Provisional application No. 61/330,578, filed on May 3, 2010.

(51) Int. Cl. H04W 4/14

(52) U.S. Cl. 455/466

(57) ABSTRACT

The invention relates to a method and network node for sending a message to a plurality of devices of a user, comprising the steps of receiving a message addressed to the user from a messaging server, sending the message to the plurality of devices of the user, upon receiving a first acknowledgement from a first device of the plurality of devices of the user, sending a delivery acknowledgement to the messaging server, and if an acknowledgement was not received from at least one device of the plurality of devices of the user, re-sending the message to the at least one device.

### PRIORITY STATEMENT UNDER 35 U.S.C. S.119(E) & 37 C.F.R. S.1.78

This non-provisional patent application claims priority based upon the prior U.S. provisional patent application entitled “SMS MULTI-DEVICE SUPPORT”, application No. 61/330,578, filed May 3, 2010, in the name of Patrice Varinot.

### TECHNICAL FIELD

The present invention relates generally to the delivery of messages, such as Short Message Service (SMS) messages.

### BACKGROUND

Short Message Service (SMS) messaging is well understood by those in the art. It is frequently used by users of mobile devices to send short messages to other mobile device users.

End to end SMS messaging has evolved to provide a transport mechanism that delivers the message to a single intended receiver. It is however possible for a sender to specify one or multiple recipients for an SMS.

Today, the SMS Centre (SMS-C) in the sender's network is responsible for delivery of the message, or for notifying the sender of the inability of the message to be delivered. This is even the case for situations where the sender and receiver are on different networks.

A second node, the SMS Router (SMS-R) has been introduced in 3rd Generation Partnership Project (3GPP) Technical Specification (TS) 29:002 Version 7 and higher and 3GPP TS 23:004 V7 and higher standards. This allows the receiver network to provide services to the receiver. For reasons of backwards compatibility, the SMS-C (or the node that provides the equivalent functionality) in the sender's network is still responsible for delivery and retry functionality.

At present, it is not possible for an SMS-C in the sender's network to have the delivery information for a user in another network. The SMS-C in the sender's network may not be able to receive information about subscribers in other network for either technical or privacy related reasons and thus services to users may still be limited.

### SUMMARY

Therefore, it would be desirable to provide a system and method that obviate or mitigate the above described problem.

There is provided a method for sending a message to a plurality of devices of a user, comprising the steps of receiving a message addressed to the user from a messaging server, sending the message to the plurality of devices of the user, upon receiving a first acknowledgement from a first device of the plurality of devices of the user, sending a delivery acknowledgement to the messaging server, and if an acknowledgement was not received from at least one device of the plurality of devices of the user, re-sending the message to the at least one device.

There is also provided a network node, comprising an input/output (I/O) interface, a processor, and a memory storing instructions for execution by the processor. The instructions comprising receiving a message addressed to a user from a messaging server through the I/O interface, sending the message to a plurality of devices of the user through the I/O interface, upon receiving a first acknowledgement from a first device of the plurality of devices of the user through the I/O interface, sending a delivery acknowledgement to the messaging server, and if an acknowledgement was not received from at least one device of the plurality of devices of the user, re-sending the message to the at least one device through the I/O interface.

### BRIEF DESCRIPTION OF THE DRAWINGS

The objects and advantages of the invention will be understood by reading the detailed description in conjunction with the figures, wherein:

FIG. 1 is a flowchart of a method according to the invention;

FIG. 2 is a block diagram of a network node according to the invention; and

FIG. 3 illustrates an architecture for the delivery of messages to multiple devices according to an embodiment of the present invention.

### DETAILED DESCRIPTION

The various features of the invention will now be described with reference to the figures. These various aspects are described hereafter in greater detail in connection with exemplary embodiments and examples to facilitate an understanding of the invention, but should not be construed as limited to these embodiments. Rather, these embodiments are provided so that the disclosure will be thorough and complete, and will fully convey the scope of the invention to those skilled in the art.

Many aspects of the invention are described in terms of sequences of actions or functions to be performed by elements of a computer system or other hardware capable of executing programmed instructions. It will be recognized that the various actions could be performed by specialized circuits (e.g., discrete logic gates interconnected to perform a specialized function), by program instructions being executed by one or more processors, or by a combination of both. Moreover, the invention can additionally be considered to be embodied entirely within any form of computer readable carrier, such as solid-state memory, magnetic disk, optical disk or carrier wave (such as radio frequency, audio frequency or optical frequency carrier waves) containing an appropriate set of computer instructions that would cause a processor to carry out the techniques described herein. Thus, the various aspects of the invention may be embodied in many different forms, and all such forms are contemplated to be within the scope of the invention.

The embodiments according to the present invention are described with reference to block diagrams and/or operational illustrations of methods, servers, and computer program products. In some implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Furthermore, in some illustrations, some blocks may be optional and may or may not be executed; these are generally illustrated with dashed lines.

At present, it is not possible for a Short Message Service (SMS) Center (SMS-C) in a sender's network to have the delivery information or information about subscribers in other networks for either technical or privacy related reasons. Therefore, the SMS-C in the sender's network is somewhat limited when it comes to delivering a message according to user defined rules.

Today, it is not possible for a user to specify that he is associated with a number of different devices that should all receive messages, e.g. SMS messages, addressed to him. Therefore, the present invention is directed to a system and method for delivery of messages to a plurality of receivers, e.g. a pool of devices of a user, based on a single receiver address.

Even if the SMS-C in the sending network is able to obtain the set of multiple numbers associated with a subscriber, questions of who should be paying for the delivery of multiple messages for a single sent message arise. In order to be able to put the invention into practice and solve these problems, the SMS Router (SMS-R) node is put at contribution.

In embodiments of the present invention, backwards compatibility is maintained, as is standards compliance, by ensuring that the SMS-C in the sending network is considered as the node responsible for delivery of the message. However, the SMS-R in the receiving network is placed in charge of delivery of the SMS message to more than one device based on a receiver profile. The SMS message can be considered as being successfully delivered if it has been delivered to at least one active device. If none of the receiver devices is active, the SMS-C will still retain responsibility for retrying the transmission of the message according to its own set of rules. In a presently preferred embodiment, if a single receiver is active and has received the message, it will be considered as having been delivered. The SMS-R may retry the other devices at a later time if so configured.

For the SMS-R to be able to take charge of the message according to the originator request, some information not presently included in the standard delivery of the SMS message may be required. If the SMS-R is responsible for attempting retransmission of a message to the specified devices that did not previously receive a message, the SMS-C will preferably provide the Validity Period associated with the message, and other related retry information. In an alternate embodiment, the SMS-R will have predefined rules associated with other SMS-C's. In such a case, the Validity Period may be agreed upon a priori and need not be included in the delivery of the SMS message. In cases where an SMS-C does not provide a Validity Period, a predefined value can be used, this value may be specific to the SMS-C the message has been received from or may be determined at the SMS-R.

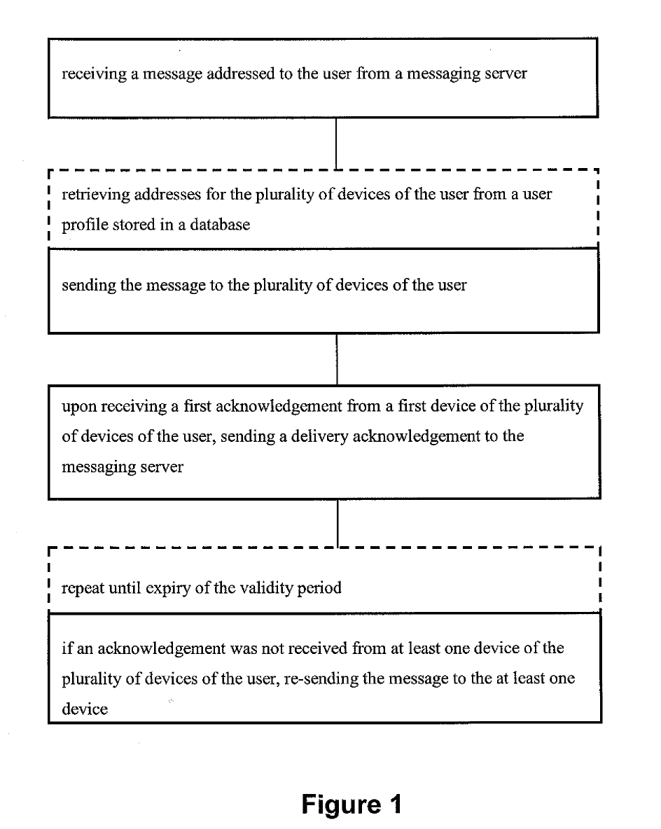

Referring to FIG. 1, the invention provides a method for sending a message to a plurality of devices of a user. The method comprises the steps of receiving a message addressed to the user from a messaging server, step 100. In the preferred embodiment, the message is received in an SMS message, but the method could also apply to other types of messages such as Multimedia Messaging Service (MMS), emails, messages sent during a chat, etc, as it would be apparent to a person skilled in the art. The method also comprises the step of sending the message to the plurality of devices of the user, step 104. The addresses of the individual devices may be stored in a user profile, which may be stored in a database. Therefore these addresses of devices of the user may be retrieved from this user profile, optional step 102. The method further comprises the step of sending a delivery acknowledgement to the messaging server upon receiving a first acknowledgement from a first device of the plurality of devices of the user, step 106. The method also comprises the step of re-sending the message to at least one device, if an acknowledgement was not received from at least one device of the plurality of devices of the user, step 110. A validity period may be associated with the message and the step of re-sending may be executed repeatedly, step 108, until expiry of the validity period. The validity period may be defined by the messaging server and be sent within the message. Otherwise, the validity period may be a fixed predefined value.

Preferably, the messaging server is an SMS-C and the method is executed in an SMS-R. The SMS-R may have predefined rules associated with the SMS-C and one of the rules may define a validity period. Furthermore, the rules may comprise types of reasons for non-delivery and actions to be performed associated with these reasons, such as absent subscriber, Mobile Station (MS) memory capacity exceeded, network error that may apply or other error types that can be assimilate to permanent error and that have to be sent back to the SMSC for final action.

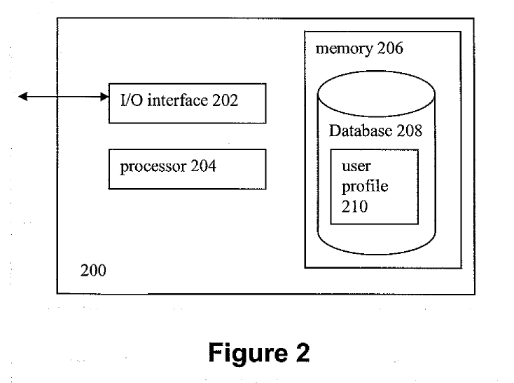

Now referring to FIG. 2, the invention also provides a network node 200, comprising an I/O interface 202, a processor 204, and a memory 206 storing instructions for execution by the processor. A person skilled in the art will understand that the memory may be interchangeably a non-volatile memory such as a hard drive or a volatile memory such as a Random Access Memory (RAM), for example, or any other type of equivalent memory. The I/O interface can take any from known to a person in the art and could consist of a plurality of interfaces or communication modules. The instructions comprise instructions for executing the method described above. The network node may further comprise in its memory 206, a database 208 which can store a validity period either associated with the message, predefined for the network node or predetermined for the messaging server, for example. The database, may also comprise a user profile 210 comprising addresses for the plurality of devices of the user.

Preferably, the network node is an SMS-R and the messaging server is an SMS-C. The SMS-R may have predefined rules associated with the SMS-C stored in the memory and one rule defining a validity period. The rules may also comprise types of reasons for non-delivery and actions to be performed associated these reasons.

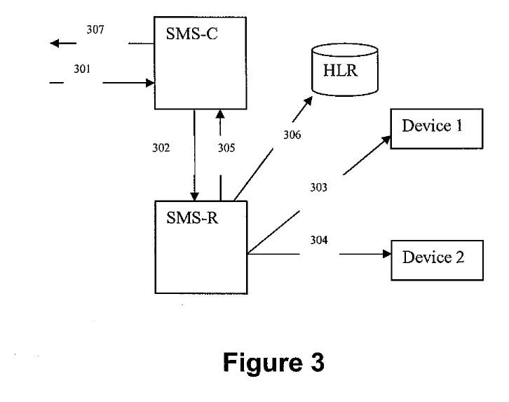

Turning to FIG. 3, an originating subscriber sends a message to the SMS-C addressed to a subscriber associated with SMS-R in flow 301. The SMS is forwarded to the SMS-R in a MAP_MT-FWD message in message flow 302. The validity period for the message is preferably included in this message as described above. This is preferably done using the same parameters as in TP-Validity-Period (see the 3GPP TS 23:040 standard). The SMS-R keeps the validity period information. If the validity period is not provided in the MAP_MT-FWD, the current SMS-R validity period can be assumed for the presently discussed embodiment.

In message flows 303 and 304, the SMS-R delivers the SMS message to multiple devices by forking it to the multiple receiver devices. The SMS-R is now responsible to track answers from the forked messages and to ack or nack the SMS-C on response(s) from the forked messages to their device(s) recipient(s). In the SMS-R, a subscriber identified by an address, such as a mobile device number, is associated with a plurality of devices. When a message is received, a lookup, e.g. in database tables containing a user profile, as illustrated in FIG. 2, is performed to determine which devices the message should be delivered to.

In message flow 305, where at least one device acknowledges positively to the message delivery, the SMS-R takes ownership of the SMS message delivery. In a presently preferred embodiment, it retries delivery of the SMS message to the devices that have not acknowledged successful reception. This is repeated until expiry of the Validity Period, or successful delivery. One skilled in the art will appreciate that variations in the mechanism for retrying the delivery of the message can be implemented without departing from the scope of the present invention. Because the SMS-C does not interact with the multi-device delivery, charging for the multiple deliveries of messages can be done at the SMS-R level. SMS queues may or may not be requested per destination subscriber's devices depending on the implementation. A unique queue for all devices may request to maintain delivery information per device in addition to the message(s) content.

In message flow 306, where not all devices are not available for delivery, the SMS-R can perform different actions based on the reasons for non-delivery. If the report is a failure report indicating “absent subscriber” via the Mobile Switching Center (MSC) or the Serving General Packet Radio Service (GPRS) Support Node (SGSN), the SMS-R can request that the Home Location Register (HLR) insert its address into the Message-Waiting-Data (MWD) (if implemented) with cause Absent Subscriber (“SM_DeliveryReportStatus”). The MWD is part of the Messages-Waiting-Indication (MWI) to be stored in the HLR and consists of an address list of the Service Centers (SC)s which have messages waiting to be delivered to the MS. MWI consists of data to be stored in the HLR and Visitor Location Register (VLR) with which an MS is associated, indicating that there is one or more messages waiting in a set of SCs to be delivered to the MS (due to unsuccessful delivery attempt(s)). The SMS-R can also inform the HLR of the reason for the MS being absent via the MSC or the SGSN (if this information is available). If the report is a failure report indicating “MS memory capacity exceeded” via the MSC or the SGSN, the SMS-R can request that the HLR insert its address into the MWD (if implemented) with cause MS Memory Capacity Exceeded via the MSC or the SGSN (“SM_DeliveryReportStatus”). The SMS-R can also take appropriate measures to retry the message when the device is made available.

In message flow 307, the SMS-C, on per request or SMS-C configuration setting can create a Status report of the successful delivery of the message on reception of the SMS-DELIVER_Report from the SMS-R.

In implementing the above described method, the SMS-R may advantageously provide support for Mobile Application Protocol (MAP)-report-delivery-status, MAP-alert-service-center, MAP-inform-service-center as a transiting node. When it takes full responsibility of delivery, it preferably acts upon reception of the message.

In implementing the present invention, it may be advantageous for the SMS-R to be provided with the validity period so that it can retry message delivery to multiple devices. The SMS-R is preferably provided with a mechanism by which it takes ownership of a message when it is able to deliver the message to at least one of the recipients. In line with this ownership the SMS-R can report to the SMS-C that the message has been delivered and then continue to attempt delivery as specified by its configuration. The SMS-R can functionally communicate to the HLR to register retry messages on unsuccessful delivery of an SMS message to a mobile device in the list of devices associated with an address or user. The SMS-R may also have the ability to define a hierarchy among devices associated with an address or user, which may allow for the designation of primary and secondary devices (and other levels if necessary). When a message has been delivered to at least one of the devices, the SMS-R is able to delete the stored message upon either delivery to the remaining devices or upon expiry of the Validity Period associated with the message.

Those skilled in the art will appreciate that whereas in the prior art, the SMS-C is solely responsible for delivery of a message, in the present invention, the SMS-R can assume some of that responsibility. The SMS-R can receive a message from the SMS-C that is addressed to a subscriber associated with multiple delivery instructions. Message delivery is attempted, and as long as one of the plurality of associated devices is able to receive the message, the SMS-R reports that the message has been delivered. In such a situation, the SMS-R will re-attempt delivery of the message per a set of instructions. These instructions can be message specific and included with the message, they can be SMS-C specific and agreed upon a priori, or they can be simply a set of rules established at the SMS-R (those skilled in the art will appreciate that this list is not intended to be exhaustive). In the absence of message specific instructions, either SMS-C specific, or SMS-R rule based delivery re-attempt policies can be implemented.

The same function described above can also be applied to IP-Short-Message-Gateway (IP-SM-GW) node as defined per 3GPP TS 23:040 and 3GPP TS 29:002, TS 23:204 and TS 23:341.

The invention has been described with reference to particular embodiments. However, it will be readily apparent to those skilled in the art that it is possible to embody the invention in specific forms other than those of the embodiments described above. The described embodiments are merely illustrative and should not be considered restrictive in any way. The scope of the invention is given by the appended claims, rather than the preceding description, and all variations and equivalents that fall within the range of the claims are intended to be embraced therein.

1. A method for sending a message to a plurality of devices of a user, comprising the steps of:
a) receiving a message addressed to the user from a messaging server;
b) sending the message to the plurality of devices of the user;
c) upon receiving a first acknowledgement from a first device of the plurality of devices of the user, sending a delivery acknowledgement to the messaging server; and
d) if an acknowledgement was not received from at least one device of the plurality of devices of the user, re-sending the message to the at least one device.

2. The method of claim 1, wherein a validity period is associated with the message and wherein step d) of re-sending is executed repeatedly until expiry of the validity period.

3. The method of claim 2, wherein the validity period is defined by the messaging server and is sent within the message.

4. The method of claim 2, wherein the validity period is a fixed predefined value.

5. The method of claim 1, wherein the messaging server is an SMS-C and the method is executed in an SMS-R.

6. The method of claim 5, wherein the SMS-R has predefined rules associated with the SMS-C and wherein a rule defines a validity period.

7. The method of claim 6, wherein the rules comprise types of reasons for non-delivery and actions to be performed associated therewith.

8. The method of claim 1, wherein step a) further comprises retrieving addresses for the plurality of devices of the user from a user profile stored in a database.

9. A network node, comprising:
an I/O interface;
a processor; and
a memory storing instructions for execution by the processor, said instructions comprising:
receiving a message addressed to a user from a messaging server through the I/O interface;
sending the message to a plurality of devices of the user through the I/O interface;
upon receiving a first acknowledgement from a first device of the plurality of devices of the user through the I/O interface, sending a delivery acknowledgement to the messaging server; and
if an acknowledgement was not received from at least one device of the plurality of devices of the user, re-sending the message to the at least one device through the I/O interface.

10. The network node of claim 9, wherein a validity period is associated with the message and wherein the instruction to re-send is executed repeatedly until expiry of the validity period.

11. The network node of claim 10, wherein the validity period is defined by the messaging server and is sent within the message.

12. The network node of claim 10, wherein the validity period is a fixed predefined value stored in the memory.

13. The network node of claim 9, wherein the messaging server is an SMS-C and the network node is an SMS-R.

14. The network node of claim 13, wherein the SMS-R has predefined rules associated with the SMS-C stored in the memory and wherein a rule defines a validity period.

15. The network node of claim 13, wherein the rules comprise types of reasons for non-delivery and actions to be performed associated therewith.

16. The network node of claim 9, wherein the memory further comprises a user profile stored in a database, the user profile comprising addresses for the plurality of devices of the user.
